(19) United States
(12) Patent Application Publication
(10) Pub. No.: US 2020/0089241 A1
(43) Pub. Date: Mar. 19, 2020

(54) INTELLIGENT MOTOR VEHICLES, SYSTEMS, AND CONTROL LOGIC FOR REAL-TIME ECO-ROUTING AND ADAPTIVE DRIVING CONTROL

(71) Applicant: GM Global Technology Operations LLC, Detroit, MI (US)

(72) Inventors: Chi-Kuan Kao, Troy, MI (US); Steven E. Muldoon, Royal Oak, MI (US); Chen-Fang Chang, Bloomfield Hills, MI (US); Edward Gundlach, West Bloomfield, MI (US)

(73) Assignee: GM Global Technology Operations LLC, Detroit, MI (US)

(21) Appl. No.: 16/130,367

(22) Filed: Sep. 13, 2018

(51) Int. Cl. G05D 1/02; G05D 1/00; G01C 21/34; G01C 21/36

(52) U.S. Cl. CPC G05D 1/0217; G05D 1/0088; G01C 21/36; G01C 21/3492; G01C 21/3469

(57) ABSTRACT

Presented are intelligent vehicle systems and control logic for predictive route planning and adaptive control, methods for manufacturing/operating such systems, and motor vehicles with real-time eco-routing and automated driving capabilities. A method for controlling operation of a vehicle includes determining vehicle origin and destination information, and identifying candidate routes for traversing from the origin to the destination. Road-level data, including speed and topology data, is received for each candidate route. Total energy uses are estimated for propelling the vehicle from the origin to the destination across each of the candidate routes. This estimating includes evaluating respective road-level data of each candidate route against a memory-stored table that correlates energy consumption to speed, turn angle, and/or gradient. A resident vehicle controller commands a resident vehicle subsystem to execute a control operation based on one or more of the estimated total energy uses corresponding to one or more of the candidate routes.

### STATEMENT REGARDING FEDERALLY SPONSORED RESEARCH AND DEVELOPMENT

This invention was made with U.S. Government support under Contract No. DE-AR0000790 between General Motors, LLC, and the United States Department of Energy (DOE). The government has certain rights in the invention.

### INTRODUCTION

The present disclosure relates generally to vehicle energy use estimation and route planning. More specifically, aspects of this disclosure relate to intelligent motor vehicles with control logic for predictive eco-route planning and adaptive driving control.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving power to the vehicle's road wheels through a manually or automatically shifted multi-speed transmission and a final drive system (e.g., differential, axle shafts, etc.). Automobiles have historically been powered by a reciprocating-piston type internal combustion engine (ICE) assembly due to its ready availability and relatively inexpensive cost, light weight, and overall efficiency. Such engines include two and four-stroke compression-ignited (CI) diesel engines, four-stroke spark-ignited (SI) gasoline engines, six-stroke architectures, and rotary engines, as some non-limiting examples. Hybrid and full electric vehicles, on the other hand, utilize alternative power sources to propel the vehicle and, thus, minimize or eliminate reliance on a fossil-fuel based engine for power.

Hybrid vehicle powertrains utilize multiple sources of traction power to propel the vehicle, most commonly operating an internal combustion engine assembly in conjunction with a battery-powered or fuel-cell-powered electric motor. A hybrid electric vehicle (HEV), for example, stores both electrical energy and chemical energy, and converts the same into mechanical power to drive the vehicle's road wheels. The HEV is generally equipped with an electric machine (E-machine), often in the form of a motor/generator unit (MGU), that operates in parallel or in series with an ICE. Series hybrid architectures derive all tractive power from electric motor(s) and, thus, eliminate any driving mechanical connection between the engine and final drive members. By comparison, the engine and motor/generator assemblies of parallel hybrid architectures each have a driving mechanical coupling to the power transmission. Since hybrid vehicles are designed to derive their power from sources other than the ICE, engines in HEVs may be turned off, in whole or in part, while the vehicle is propelled by the electric motor(s).

A full electric vehicle (FEV)—colloquially known as an “electric car”—is an alternative type of electric-drive vehicle configuration that altogether eliminates the internal combustion engine and attendant peripheral components from the powertrain system, relying solely on electric traction motors for vehicle propulsion. Battery electric vehicles (BEV), for example, utilize energy stored within a rechargeable, onboard battery pack, rather than a fuel tank, fuel cell, or fly-wheel, to power the electric motor(s). The electric vehicle employs an electrical power distribution system governed via a powertrain control module (PCM) for transmitting electrical energy back-and-forth between the onboard battery pack and the electric motor(s). Plug-in electric vehicle (PEV) variants allow the battery pack to be recharged from an external source of electricity, such as a public power grid, via a residential or commercial vehicle charging station.

As vehicle processing, communication, and sensing capabilities continue to improve, manufacturers persist in offering more system-automated driving capabilities with the aspiration of eventually offering fully autonomous vehicles competent to operate among heterogeneous vehicle types in both urban and rural scenarios. Original equipment manufacturers (OEM) are moving towards vehicle-to-vehicle (V2V) and vehicle-to-infrastructure (V2I) “talking” cars, integrating wireless connectivity (e.g., Dedicated Short Range Communications or DSRC) with higher-level driving automation features that employ autonomous steering, braking, and powertrain systems to enable driverless vehicle operation. Automated route generation systems utilize vehicle state and dynamics sensors, roadway map data, and path prediction algorithms to provide vehicle routing and rerouting with automated lane center and lane change forecasting, scenario planning, etc. For purposes of this disclosure, “automated vehicles” and “autonomous vehicles” and “connected automated/autonomous vehicles” (CAVs) may be used synonymously and interchangeably to denote vehicles with partially assisted and/or fully autonomous driving capabilities, including any relevant vehicle platform that may be classified as a Society of Automotive Engineers (SAE) Level 2, 3, 4 or 5 vehicle.

Many automobiles are now equipped with an onboard vehicle navigation system that utilizes a global positioning system (GPS) transceiver in cooperation with navigation software and a mapping database to obtain roadway topography, traffic and speed limit information associated with the vehicle's current location. Advanced driver assistance systems (ADAS) and autonomous driving systems are often able to adapt certain automated driving maneuvers based on roadway information obtained by the in-vehicle navigation system. Ad-hoc-network-based ADAS, for example, employ GPS and mapping data in conjunction with multi-hop geocast V2V and V2I data exchanges to facilitate automated vehicle maneuvering and powertrain control. During assisted and unassisted vehicle operation, the resident navigation system may determine a recommended travel route based on an estimated shortest time or estimated shortest distance between a route origin and a route destination for a given trip. This recommended travel route may then be displayed as a map trace or as turn-by-turn driving directions on a geocoded and annotated map. Such conventional approaches to route planning, while effective at determining the shortest travel distance/time to a desired destination, do not account for the most energy efficient routes or the most favorable routes for governing vehicle operation.

### SUMMARY

Disclosed herein are intelligent vehicle systems with attendant control logic for predictive route planning and adaptive control, methods for manufacturing and methods for operating such systems, and motor vehicles with real-time eco-routing and adaptive driving control capabilities. By way of example, there are presented novel eco-routing algorithms that monitor real-time traffic conditions and road-level data to derive vehicle energy consumption estimates from which the system generates alternative, more energy-efficient routes. Autonomous and automated vehicle driving control may operate as a closed-loop system that actively adapts fuel consumption data (e.g., stored in resident cache memory as a look-up table) with sensor-measured values. Model-based, probabilistic route planning for energy efficient vehicle operation can be computationally intensive and, thus, impractical for execution by resident vehicle hardware. Comparatively, disclosed eco-routing strategies yield significant computational savings by employing vehicle-calibrated energy consumption look-up tables in conjunction with a geopositional map application and a traffic application programming interface (API) to derive an energy consumption estimate for each candidate route to traverse from a given origin to a desired destination. In addition to reducing in-vehicle processing loads, disclosed eco-routing techniques help to increase vehicle fuel economy or extend eDriving range (e.g., for HEV and FEV applications) while improving ADAS and autonomous driving functionality.

Aspects of this disclosure are directed to real-time eco-routing techniques and adaptive driving control algorithms for optimizing vehicle energy usage. For instance, a method is presented for controlling operation of a motor vehicle. The vehicle includes multiple road wheels, a prime mover (e.g., ICE and/or MGU) that is operable to drive one or more of the road wheels, and a resident vehicle controller that controls the prime mover. This representative method includes, in any order and in any combination with any of the above and below disclosed options and features: determining, e.g., via the resident vehicle controller through cooperative operation with a graphical human-machine interface (HMI) and a GPS transceiver, cellular data chip, etc., a vehicle origin and a vehicle destination for the motor vehicle; conducting, e.g., via the resident vehicle controller through a resident or remote memory-stored map database, a geospatial query to identify a plurality of candidate routes for traversing from the vehicle origin to the vehicle destination; receiving, e.g., via the resident vehicle controller from the map database or a cloud computing resource service that collects crowd-sourced vehicle dynamics data, road-level data—speed, turn angle, and/or gradient data—associated with each candidate route; estimating, e.g., via the resident vehicle controller, a respective total energy use of the prime mover to propel the motor vehicle from the vehicle origin to the vehicle destination across each of the candidate routes, the estimating including evaluating the respective road-level data of each candidate route against memory-stored data (e.g., one or more look-up tables) that correlates energy consumption to speed, turn angle and/or gradient; and transmitting, via the resident vehicle controller, one or more command signals to a resident vehicle subsystem to execute a control operation based on one or more of the estimated total energy uses corresponding to one or more of the candidate routes.

Other aspects of the present disclosure are directed to intelligent motor vehicles with real-time eco-routing and adaptive driving control capabilities. As used herein, the term “motor vehicle” may include any relevant vehicle platform, such as passenger vehicles (internal combustion, hybrid, full electric, fuel cell, etc.), commercial vehicles, industrial vehicles, tracked vehicles, off-road and all-terrain vehicles (ATV), motorcycles, farm equipment, boats, airplanes, etc. In an example, a motor vehicle includes a vehicle body with multiple road wheels operatively attached to the vehicle body. A prime mover, which is mounted onto the vehicle body, drives one or more of the road wheels to thereby propel the vehicle. The motor vehicle is also equipped with a resident vehicle navigation system that is attached to the vehicle body, e.g., mounted inside the passenger compartment. The vehicle navigation system includes a vehicle location tracking device, one or more electronic user input devices, and an electronic display device.

Continuing with the discussion of the above example, a resident vehicle controller is attached to the body of the motor vehicle and communicatively connected to the prime mover, navigation system, etc. This vehicle controller is programmed to execute memory-stored instructions to: determine a vehicle origin and vehicle destination for the motor vehicle; conduct, via a memory-stored map database, a geospatial query to identify a plurality of candidate routes for the motor vehicle to traverse from the vehicle origin to the vehicle destination; receive respective road-level data associated with each of the candidate routes, the road-level data including speed data and turn angle and/or gradient data; estimate a respective total energy use of the prime mover to propel the motor vehicle from the vehicle origin to the vehicle destination across each of the candidate routes, the estimating including evaluating the respective road-level data of the candidate route against a memory-stored table correlating energy consumption to speed and turn angle and/or gradient; and, transmit a command signal to a resident vehicle subsystem to execute a control operation based on at least one of the estimated total energy uses corresponding to at least one of the candidate routes

For any of the disclosed systems, methods, and vehicles, estimating the total energy use for a candidate route may include: dissecting a candidate route into multiple road segments; determining, from road-level data stored in the memory-stored map database, an average speed, average turn angle, and average gradient for each road segment; estimating a vehicle energy use for each road segment by evaluating the respective average speed, turn angle, and gradient of the road segment against the memory-stored table correlating energy consumption to speed and turn angle and/or gradient; and, aggregating the vehicle energy uses of the various road segments to thereby estimate the total energy use for the candidate route under analysis. As another option, estimating the total energy use for a candidate route may include: receiving vehicle dynamics data indicative of speed, turn angle, and gradient for multiple participatory vehicles while travelling on the candidate route for a fixed time window; determining, from the received vehicle dynamics data, an average speed, average turn angle, and average gradient for the candidate route; and, estimating the total energy use for each candidate route by evaluating the average speed, turn angle, and gradient of the candidate route against the table correlating energy consumption to speed and turn angle and/or gradient.

For any of the disclosed systems, methods, and vehicles, an in-vehicle electronic display device may display each candidate route contemporaneous with an indication of its respective estimated total energy use. A resident vehicle controller may then receive, via an electronic user input device, a user selection of one of the displayed candidate routes. Once selected, the resident vehicle controller may determine if a disturbance event (e.g., a collision, inclement weather, etc.) has increased an estimated travel time for the selected candidate route by at least a predetermined threshold time (e.g., a preset time value or a preset time percentage). Responsive to the disturbance event increasing the estimated travel time by at least the predetermined threshold time, the electronic display device displays a prompt to select another one of the candidate routes. As another option, if it is determined that the disturbance event increased the estimated travel time by the predetermined threshold time, the resident vehicle controller may conduct another geospatial query to identify alternate candidate routes, estimate a total energy use for each alternate candidate route, and command the electronic display device to display each alternate candidate route contemporaneous with an indication of its respective estimated total energy use.

For any of the disclosed systems, methods, and vehicles, an estimated travel time and distance may be determined for each candidate route. In this instance, the control operation is further based on one or more of the estimated travel times/distances for one or more of the candidate routes. As another option, the memory-stored table may include a first look-up table that correlates energy consumption to speed and turn angle, and also defines a first optimal operating region that has been determined to minimize vehicle energy use. The memory-stored table also includes a second look-up table that correlates energy consumption to speed and gradient, and also defines a second optimal operating region that has been determined to minimize vehicle energy use. In either of the foregoing instances, an autonomous driving control module, which is operable to automate driving of the motor vehicle, may operate the motor vehicle within the first or second optimal operating region.

For any of the disclosed systems, methods, and vehicles, the resident vehicle controller may receive, e.g., from a distributed array of in-vehicle sensors, real-time energy consumption data that is indicative of actual energy use of the prime mover at designated speeds, turn angles and/or gradients corresponding to sample points within the memory-stored table. For each sample point, the controller determines if the actual energy use value is different from a memory-store energy use value for the sample point by at least a predetermined delta. If so, the controller will responsively update the memory-stored table to replace the memory-store energy use value with the actual energy use value. Prior to receiving the real-time energy consumption data, the vehicle controller may determine if the motor vehicle is operating at a speed and turn angle or a speed and gradient that corresponds to any one of the sample points within the memory-stored table.

For any of the disclosed systems, methods, and vehicles, the resident vehicle subsystem may include an ADAS control module that is operable to govern driving of the motor vehicle. In this instance, the control operation includes executing an automated steering maneuver and/or an automated cruise control maneuver that has been adapted by the ADAS control module based on at least one of the estimated total energy uses for at least one of the candidate routes. Optionally, the resident vehicle subsystem may include a vehicle navigation system with an electronic display device. In this instance, the control operation includes saving the estimated total energy uses for the candidate routes in the memory-stored map database and/or displaying each candidate route contemporaneous with an indication of its estimated total energy use on the electronic display device.

The above summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic illustration of a representative motor vehicle with a network of in-vehicle controllers, sensing devices, and communication devices for executing eco-routing techniques and automated driving operations in accordance with aspects of the present disclosure.

FIG. 2 is a flowchart illustrating a representative eco-routing control algorithm for estimating total vehicle energy consumption to provision intelligent route planning, which may correspond to memory-stored instructions executed by onboard or remote control-logic circuitry, programmable electronic control unit, or other computer-based device or network of devices in accord with aspects of the disclosed concepts.

FIGS. 3A and 3B are graphs illustrating fuel consumption as a function of vehicle speed and turning angle for a representative motor vehicle in accord with aspects of the disclosed concepts.

FIGS. 4A and 4B are graphs illustrating fuel consumption as a function of vehicle speed and gradient for a representative motor vehicle in accord with aspects of the disclosed concepts.

FIG. 5 is a flowchart illustrating a representative real-time learning algorithm for adapting fuel consumption look-up tables to an individual vehicle/driver, which may correspond to memory-stored instructions executed by onboard or remote control-logic circuitry, programmable electronic control unit, or other computer-based device or network of devices in accord with aspects of the disclosed concepts.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed by the appended claims.

### DETAILED DESCRIPTION

This disclosure is susceptible of embodiment in many different forms. Representative embodiments of the disclosure are shown in the drawings and will herein be described in detail with the understanding that these representative examples are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a normal driving surface.

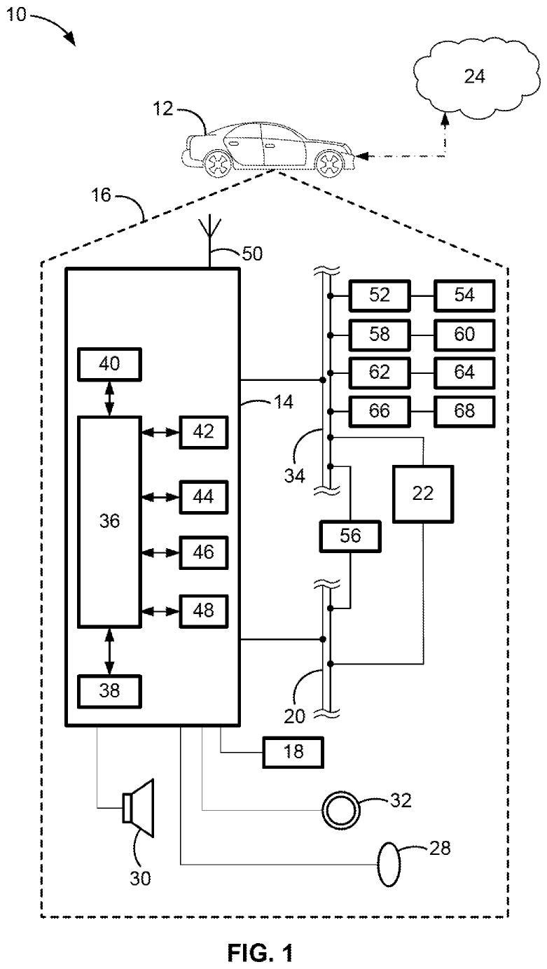

Referring now to the drawings, wherein like reference numbers refer to like features throughout the several views, there is shown in FIG. 1 a representative automobile, which is designated generally at 10 and portrayed herein for purposes of discussion as a sedan-style passenger vehicle. Packaged on a vehicle body 12 of the automobile 10, e.g., distributed throughout the different vehicle compartments, is an onboard network of electronic devices for executing one or more assisted or automated driving operations. The illustrated automobile 10—also referred to herein as “motor vehicle” or “vehicle” for short—is merely an exemplary application with which aspects and features of this disclosure may be practiced. In the same vein, implementation of the present concepts for the specific computing network architecture discussed below should also be appreciated as an exemplary application of the novel features disclosed herein. As such, it will be understood that aspects and features of this disclosure may be applied to other system architectures, utilized for various automated driving operations, and implemented for any logically relevant type of motor vehicle. Moreover, only select components of the network and vehicle have been shown and will be described in additional detail below. Nevertheless, the motor vehicles and network architectures discussed herein may include numerous additional and alternative features, and other available peripheral components, for example, to carry out the various methods and functions of this disclosure. Lastly, the drawings presented herein are not necessarily to scale and are provided purely for instructional purposes. Thus, the specific and relative dimensions shown in the drawings are not to be construed as limiting.

The representative vehicle 10 of FIG. 1 is originally equipped with a vehicle telecommunication and information (“telematics”) unit 14 that wirelessly communicates (e.g., via cell towers, base stations, V2X, and/or mobile switching centers (MSCs), etc.) with a remotely located or “off-board” cloud computing system 24. Some of the other vehicle hardware components 16 shown generally in FIG. 1 include, as non-limiting examples, an electronic video display device 18, a microphone 28, one or more audio speakers 30, and assorted input controls 32 (e.g., buttons, knobs, switches, trackpads, keyboards, touchscreens, etc.). Generally, these hardware components 16 function, at least in part, as a resident vehicle navigation system, e.g., to enable assisted and/or automated vehicle navigation, and as a human/machine interface (HMI), e.g., to enable a user to communicate with the telematics unit 14 and other systems and system components of the vehicle 10. Microphone 28 provides a vehicle occupant with means to input verbal or other auditory commands; the vehicle 10 may be equipped with an embedded voice-processing unit programmed with a computational speech recognition software module. Conversely, speaker 30 provides audible output to a vehicle occupant and may be either a stand-alone speaker dedicated for use with the telematics unit 14 or may be part of audio system 22. The audio system 22 is operatively connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switch, internal/external parallel/serial communication bus, a local area network (LAN) interface, a controller area network (CAN), a media-oriented system transfer (MOST), a local interconnection network (LIN) interface, and the like. Other appropriate communication interfaces may include those that conform with ISO, SAE, and IEEE standards and specifications. The network connection interface 34 enables the vehicle hardware 16 to send and receive signals with each other and with various systems and subsystems both within or “resident” to the vehicle body 12 and outside or “remote” from the vehicle body 12. This allows the vehicle 10 to perform various vehicle functions, such as controlling vehicle steering, governing operation of the vehicle's transmission, controlling engine throttle, engaging/disengaging the brake system, and other automated driving functions. For instance, telematics unit 14 receives and/or transmits data to/from an ADAS electronic control unit (ECU) 52, an engine control module (ECM) 54, a powertrain control module (PCM) 56, sensor interface module(s) 58, a brake system control module (BSCM) 60, and assorted other vehicle ECUs, such as a transmission control module (TCM), a climate control module (CCM), etc.

With continuing reference to FIG. 1, telematics unit 14 is an onboard computing device that provides a mixture of services, both individually and through its communication with other networked devices. This telematics unit 14 is generally composed of one or more processors 40, each of which may be embodied as a discrete microprocessor, an application specific integrated circuit (ASIC), a dedicated control module, etc. Vehicle 10 may offer centralized vehicle control via a central processing unit (CPU) 36 that is operatively coupled to one or more electronic memory devices 38, each of which may take on the form of a CD-ROM, magnetic disk, IC device, semiconductor memory (e.g., various types of RAM or ROM), etc., and a real-time clock (RTC) 42. Long-range vehicle communication capabilities with remote, off-board networked devices may be provided via one or more or all of a cellular chipset/component, a navigation and location chipset/component (e.g., global positioning system (GPS) transceiver), or a wireless modem, all of which are collectively represented at 44. Close-range wireless connectivity may be provided via a short-range wireless communication device 46 (e.g., a BLUETOOTH® unit or near field communications (NFC) transceiver), a dedicated short-range communications (DSRC) component 48, and/or a dual antenna 50. It should be understood that the vehicle 10 may be implemented without one or more of the above listed components, or may include additional components and functionality as desired for a particular end use. The various communications devices described above may be configured to exchange data as part of a periodic broadcast in a V2V communication system or other vehicle-to-everything (V2X) communication system, e.g., Vehicle-to-Infrastructure (V2I), Vehicle-to-Pedestrian (V2P), and/or Vehicle-to-Device (V2D).

CPU 36 receives sensor data from one or more sensing devices that use, for example, photo detection, radar, laser, ultrasonic, optical, infrared, or other suitable technology for executing an automated driving operation. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion and analysis hardware and software for processing raw sensor data. Digital camera 62 may use a charge coupled device (CCD) sensor or other suitable optical sensor to generate images indicating a field-of-view of the vehicle 10, and may be configured for continuous image generation, e.g., at least about 35 images generated per second. By way of comparison, range sensor 64 may emit and detect reflected radio, electromagnetic, or light-based waves (e.g., radar, EM inductive, Light Detection and Ranging (LIDAR), etc.) to detect, for example, presence, geometric dimensions, and/or proximity of an object. Vehicle speed sensor 66 may take on various forms, including wheel speed sensors that measure wheel speeds, which are then used to determine real-time vehicle speed. In addition, the vehicle dynamics sensor 68 may be in the nature of a single-axis or a triple-axis accelerometer, an angular rate sensor, an inclinometer, etc., for detecting longitudinal and lateral acceleration, yaw, roll, and/or pitch rates, or other dynamics related parameter. Using data from the sensing devices 62, 64, 66, 68, the CPU 36 identifies objects within a detectable range of the vehicle 10, and determines attributes of the target object, such as size, relative position, angle of approach, relative speed, etc.

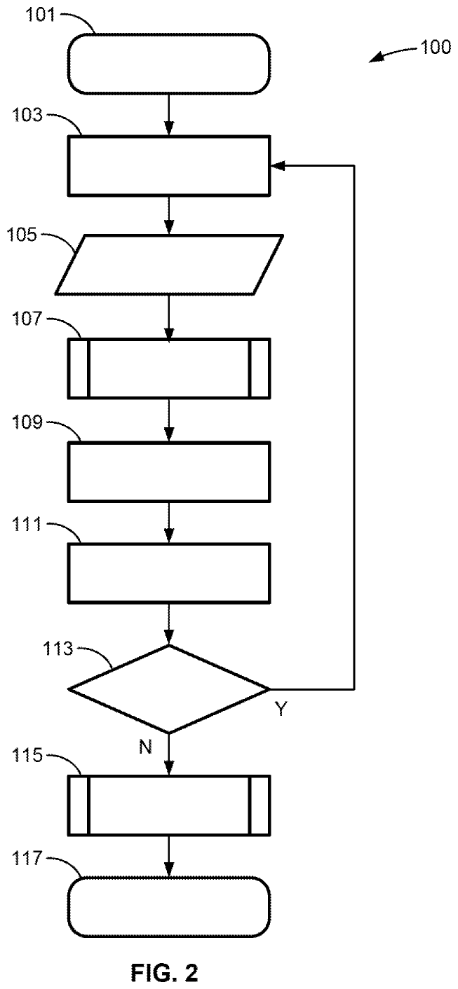

With reference now to the flowchart of FIG. 2, an improved method or control strategy for estimating total vehicle energy consumption to provision intelligent eco-route planning of a motor vehicle, such as automobile 10 of FIG. 1, is generally described at 100 in accordance with aspects of the present disclosure. Some or all of the operations illustrated in FIG. 2 and described in further detail below may be representative of an algorithm that corresponds to processor-executable instructions that may be stored, for example, in main or auxiliary or remote memory, and executed, for example, by an on-board or remote controller, processing unit, control logic circuit, or other module or device, to perform any or all of the above or below described functions associated with the disclosed concepts. It should be recognized that the order of execution of the illustrated operation blocks may be changed, additional blocks may be added, and some of the blocks described may be modified, combined, or eliminated.

Method 100 begins at terminal block 101 with processor-executable instructions for a programmable controller or control module or similarly suitable processor to call up an initialization procedure for a real-time eco-routing protocol that provides accurate fuel/battery consumption estimates, improves vehicle route planning, and helps to optimize system energy usage. This routine may be executed in real-time, continuously, systematically, sporadically and/or at regular intervals, for example, each 100 milliseconds, etc., during ongoing vehicle operation. As yet another option, terminal block 101 may initialize responsive to a command prompt from a user or a broadcast prompt signal from a backend or middleware computing node tasked with collecting, analyzing, sorting, storing and distributing vehicle data. As part of the initialization procedure at block 101, resident vehicle telematics unit 14 may execute a navigation processing code segment, e.g., to obtain geospatial data, vehicle dynamics data, timestamp and related temporal data, etc., and optionally display select aspects of this data to an occupant of the vehicle 10. A driver or other occupant of vehicle 10 may employ any of the HMI input controls 32 to select a desired origin and/or destination at process block 103. It is also envisioned that the CPU 36 or telematics unit processors 40 receive vehicle origin and destination information from other sources, such as a server-class computer provisioning data exchanges for the cloud computing system 24 or a dedicated mobile software application operating on a smartphone or other handheld computing device.

Once a vehicle origin (starting position) and vehicle destination (ending position) are confirmed at terminal block 103, the method 100 executes a geospatial query at input/output block 105 to identify candidate routes for the motor vehicle to traverse from the vehicle origin to the vehicle destination. By way of example, and not limitation, the query conducted at block 105 may utilize the vehicle's real-time location information (i.e., a set of GPS-generated geodetic datum) and temporal information (i.e., a timestamp produced by a real-time clock (RTC) of the CPU 36) to identify two or more candidate routes for reaching a selected destination from a given origin. Geospatial information may include, in some non-limiting examples, roadway geometry and boundary data, road shoulder and center location data, gradient data, intersection midpoint location data, etc. Rather than identify a single route option, which may not necessarily provide an optimal travel route for a subject vehicle on a particular day, the geospatial query of input/output block 105 identifies multiple routes corresponding to the vehicle's start and end positions. Method 100 may concomitantly access an OPENSTREETMAP® (OSM) data service or similarly suitable mapping database to “lookup” road-level data associated with each route. This baseline “road-level” information may include the interconnecting segments that form a given route, a name for each road segment, a speed limit for each road segment, lane alignment information, traffic light locations, stop sign positions, highway entrance/exit information, etc.

After establishing a vehicle origin, destination, and multiple candidate routes, and then aggregating relevant road-level data and roadway traffic/disturbance data for each route, the method 100 proceeds to predefined process block 107 to determine an estimated total vehicle energy consumption—be it fuel or battery or both—for each candidate route. Total vehicle energy consumption is based, at least in part, on respective traffic, speed and geometry information for that route. Optional implementations also account for driver-specific historical behavior and vehicle-specific operating characteristics, which will be described in extensive detail below. While it is envisioned that this information may be retrieved from any of an assortment of resources, both resident to and remote from the vehicle, it may be desirable that a resident vehicle controller, such as CPU 36 of FIG. 1, execute V2X data exchanges and access cache-memory-stored energy consumption look-up tables. These look-up tables may be generated via any suitable means, including computer simulation, system architecture emulation, crowd-sourced driving data, vehicle-calibrated driving data, etc. Where model-based eco-routing strategies routinely focus on engine-level or motor-level energy consumption, method 100 attempts to provide a more holistic assessment of total energy consumption to reach a desired destination by focusing on vehicle-level energy use.

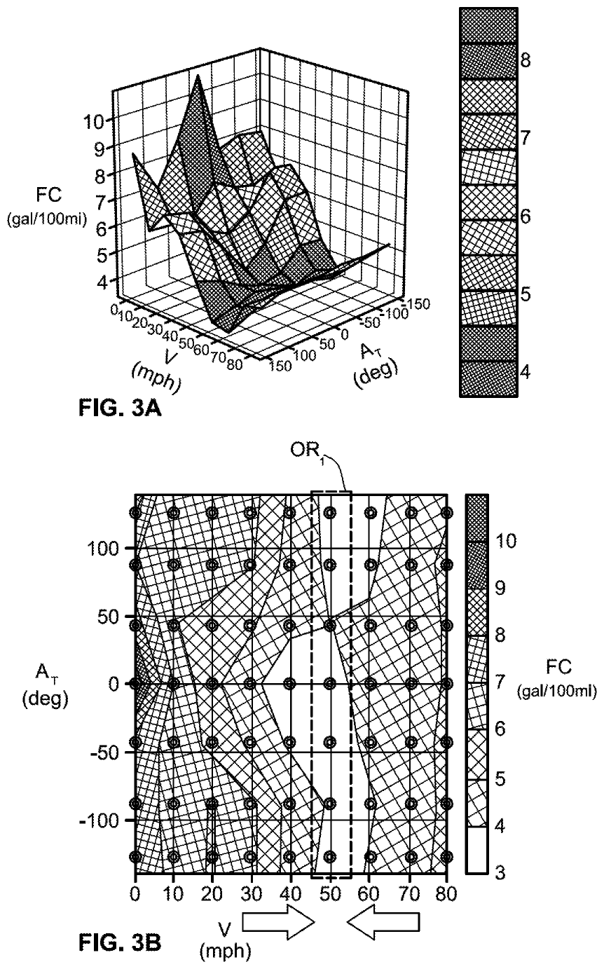

Control operations dictated at predefined process block 107 may be carried out by a resident vehicle navigation system, such as telematics unit 14 of FIG. 1, which may contain path planning software and a database of maps, tables, points of interest, and other geolocational data. FIGS. 3A and 3B graphically illustrate actual fuel usage data of a representative motor vehicle as a function of vehicle speed and turning angle. In particular, FIG. 3A is a three-dimensional (3D) surface plot exhibiting the functional relationship between three vehicle-related variables: fuel consumption FC (gallons/100 miles) as a dependent variable on the y-axis; vehicle speed V (miles per hour) as a first independent variable on the x-axis; and turning angle A_{T} (degrees) as a second independent variable on the z-axis. By comparison, FIG. 3B is a two-dimensional (2D) combined contour and scatter plot showing the turning angle A_{T} (deg.; y-axis) and vehicle speed V (mph; x-axis) associated with the various fuel consumption FC regions shown in FIG. 3A. The points overlaid on the 2D fuel consumption map of FIG. 3B represent sample points or regions that may be used to build a fuel/speed/angle look-up table. These two graphs help to demonstrate the sensitivity of vehicle fuel consumption to speed and turn angle. Using this information, automated or recommended candidate route selection (or triggered reselection) may be biased towards an (first) optimal operating region OR₁ (FIG. 3B). In accord with the illustrated example, the optimal operating region OR₁ prioritizes routes with an average vehicle speed of about 40 to 60 mph or, in some embodiments, about 47 to 55 mph, which will result in a minimized fuel consumption of about 1.0 to 4.0 gal./100 mi, generally irrespective of previous turning angle. This trend shows generally true moving from lower speeds towards higher speeds, e.g., of about 60 mph. Above 60 mph, vehicle drag effects become more dominant and, thus, increase fuel consumption. As such, it may be more desirable to reduce vehicle speeds to below 60 mph to reduce fuel usage.

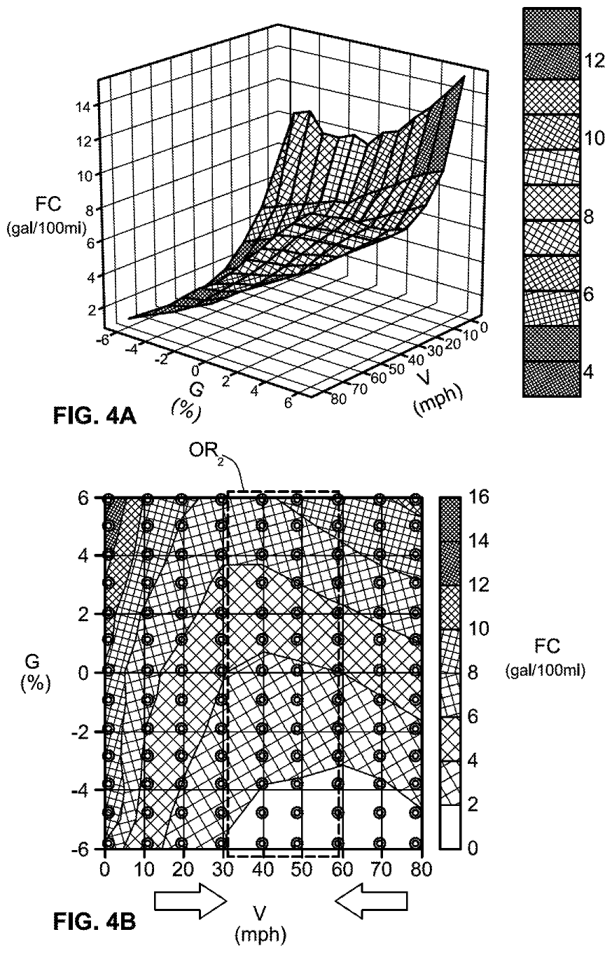

Deriving total vehicle energy consumption at predefined process block 107 may necessitate accessing supplemental or substitute sources of information to those discussed above with respect to FIGS. 3A and 3B. By way of non-limiting example, FIGS. 4A and 4B graphically illustrate actual fuel usage data of a representative motor vehicle as a function of vehicle speed and roadway gradient (i.e., incline or decline from horizontal). FIG. 4A is a 3D surface plot exhibiting the functional relationship between fuel consumption FC (gallons/100 miles; y-axis), road grade G (percentage grade ratio of rise to run; x-axis), and vehicle speed V (miles per hour; z-axis). In addition, FIG. 4B is a 2D combined contour and scatter plot showing the grade G (%; y-axis) and vehicle speed V (mph; x-axis) associated with the various fuel consumption FC regions shown in FIG. 4A. The points overlaid on the 2D fuel consumption map of FIG. 4B represent sample points or regions that may be used to build a fuel/speed/grade look-up table. These graphs help to demonstrate the sensitivity of vehicle fuel consumption to speed and roadway gradient. Using this information, candidate route selection or reselection may be biased towards an (second) optimal operating region OR₂ (FIG. 4B). In accord with the illustrated example, the optimal operating region OR₂ of FIG. 4B prioritizes routes with an average vehicle speed of about 30 to 60 mph or, in some embodiments, about 32 to 57 mph, which will result in a minimized fuel consumption of about 2.0 to 5.0 gal./100 mi for gradients of about a 3% (upward) incline to a 6% (downward) decline.

Total vehicle fuel consumption for a given candidate route may be estimated in a number of optional ways. A first method may include dissecting each candidate route into a series of interconnected road segments, with each road segment having a predetermined size (e.g., 1/10 of a mile). A candidate travel route may be segmented based on multitude of different dissection techniques including, for example: (1) each right or left turn starts a new segment; (2) each segment has approximately the same estimated travel time; (3) each segment has approximately the same travel distance; (4) each segment has approximately the same average speed; (5) each grade change on the route becomes a segment, etc. Using the road-level data retrieved at process block 105, an average speed, an average turn angle, and an average gradient is determined for each road segment. The road segment's average speed, turn angle, and gradient are then compared to the look-up tables stored in resident memory to estimate a respective vehicle energy use for that road segment. The system then sums the vehicle energy uses for all the road segments to thereby estimate a total energy use for a given candidate route. Optionally or alternatively, the CPU 36 or cloud computing system 24 receives, aggregates, and processes crowd-sourced vehicle dynamics data indicative of the speed, turn angle, and gradient for multiple participatory vehicles travelling on a subject candidate route for a fixed time window. From the received vehicle dynamics data, the system determines a respective average speed, average turn angle, and average gradient for each candidate route. The total vehicle energy use for each candidate route is then determined by evaluating the respective average speed, turn angle, and gradient for that route against the look-up tables correlating energy consumption to speed/turn angle/gradient.

An optional adaptive driving control procedure of the route planning protocol may include increasing or decreasing actual vehicle speed to shift the average vehicle speed towards one or both operating regions OR₁ and OR₂ and thereby align vehicle operation with the smallest fuel consumption at any given road grade and turn angle. By graphical analysis of FIGS. 3A, 3B, 4A and 4B, for example, the following route selection driving rules may be generated: (1) overall average vehicle speed target of approximately 50 mph; (2) general vehicle speed target operating range of approximately 30-50 mph; (3) incline grade target vehicle speed operating range of approximately 25-45 mph; and (4) decline grade target vehicle speed operating range of approximately 35-55 mph. These driving rules are non-limiting and exemplary in nature and, thus, may vary based on vehicle make, model, type, options, etc.

Route selection rules are not per se static and may be customized to individual driving styles and/or different vehicle platforms. Aggressive driving behaviors, such as hard acceleration/deceleration, excessive speeding, aggressive turns, etc., generally increase fuel consumption in the above target speeds. In addition, increased drag (e.g., coupe body vs. sedan, truck or SUV body; trailering; luggage rack; etc.) will increase vehicle fuel consumption over both maps 3B and 4B, with more detrimental drag affects at higher vehicle speeds. Engine size, gross vehicle weight, tire size and other factors may affect fuel economy for a given vehicle platform. To offset these factors, the system may shift the route selection driving rules or shrink the target operating speeds or may implement CPU-automated driving restrictions. As an additional or alternative option, CPU 36 may coordinate with a powertrain control module (PCM) to implement a set of enhanced low-energy-consumption driving rules, such as setting the vehicle 10 into “eco-driver mode,” that governs vehicle speed and limits engine/motor torque, accessory use, etc. In this regard, an ADAS module may automate one or more predetermined driving maneuvers to help preserve battery charge, including initiating adaptive cruise control (ACC) set at a calibrated speed that has been verified to optimize energy usage.

Upon completion of predefined process block 107, the method 100 of FIG. 2 continues to process block 109 with processor-executable instructions to output the total vehicle fuel consumptions for the available candidate routes. Process block 109 may include, for example, instructions for the electronic display device 18 of telematics unit 14 to display a geocoded and annotated roadway map with a vehicle origin pin, a vehicle destination pin, and discrete map traces depicting the individual candidate routes. The map traces may be color coded or numbered to provide additional means of delineation. Memory device 38 temporarily/permanently stores and display device 18 concomitantly displays a calculated vehicle fuel consumption, travel time/distance, and optional road information (e.g., traffic, toll roads, etc.) for each candidate route. For at least some applications, the CPU 36 selects or suggests one of the candidate routes as a “favored” route; a candidate route may be characterized as “favored” based on a comparison of all available candidate routes to the route selection driving rules discussed above. In a distributed computing system architecture, process block 109 may additionally or alternatively comprise communicating segments of data to the cloud computing resource service 24 for storage on a cloud server. Likewise, information may be presented to a driver or other vehicle occupant through any suitable means, be it visual, audile, tactile, or a combination of output media.

Method 100 proceeds to process block 111 whereat a user input is received to select one of the available candidate routes. Continuing with the discussion of the representative application of FIG. 1, a driver or other occupant of the vehicle 10 may employ any of the HMI input controls 32, such as a touchscreen overlaying display device 18, to choose one of the displayed candidate routes. Alternatively, the CPU 36 or telematics unit 14 processors 40 may automate selection of a “favored” route, e.g., prior to initiating a full-autonomous driving mode that will concurrently maneuver the vehicle 10 along the selected route to the desired destination. As yet a further option, a route selection may be received by the CPU 36 or telematics unit 14 from other sources, such as cloud computing resource service 24 or a dedicated mobile app operating on an occupant's smartphone, tablet or wearable electronic computing device.

Prior to, contemporaneous with, or after receiving a selection of a candidate route at process block 111, the method 100 includes a route recalculation trigger to determine if a disturbance event has significantly increased the estimated travel time or total vehicle energy consumption for any of the candidate routes. If an unforeseen traffic event has occurred on a given candidate route, the system may recalculate the estimated total vehicle energy usage/total travel time for that route. If either value increases by more than a calibrated threshold (e.g., travel time increases by more than 10 minutes or 15%; total fuel consumption increases by more than 2 gal./100 mi or 10%), the system may present alternative routes to a driver with a prompt to select another route. In an autonomous driving scenario, the vehicle 10 may automate rerouting of the vehicle 10 to coincide with an alternative route. At decision block 113, for example, the method 100 determines whether or not a disturbance event has extended an estimated travel time or increased a total vehicle energy consumption for the candidate route selected at process block 111. To make this valuation, the vehicle hardware 16 may conduct real-time monitoring (e.g., via a DSRC Radio or a cellular-based application) of travel time variations (e.g., collision, construction, etc.) on the current route. In response to a determination that a disturbance event has extended an estimated travel time or increased a total vehicle energy consumption by at least a predetermined threshold amount (block 113=Y), the system may return to input/output block 105 and loop back through method 100. For instance, the method 100 may return to the OSM data service and retrieve road-level data associated with one or more alternative routes (“reroutes”), each of which may be evaluated as a candidate route in accordance with the methodology 100 of FIG. 2.

Responsive to a determination that a disturbance event has not occurred or a disturbance event has not increased the estimated travel time/total vehicle energy consumption by their respective threshold amount (block 113=N), the method 100 proceeds to predefined process block 115 to execute a look-up table update procedure (e.g., using any of the techniques described below). By way of non-limiting example, the CPU 36 compares the calculated total fuel consumption for a selected route with the actual measured fuel consumption of the vehicle 10 upon completion of that route. If the numerical difference between the calculated value and the measured value is greater than a pre-determined value or percentage, e.g., 5 mpg or 10%, the fuel look-up table(s) may be modified to more closely align with the actual, measured value. The method 100 may thereafter proceed to terminal block 117 and terminate. On the other hand, the method 100 may thereafter loop back to terminal block 101 and run in a continuous loop.

The look-up table update procedure of predefined process block 115 may include a real-time learning and adaption procedure that adapts a vehicle energy consumption look-up table to a particular vehicle and/or an individual driving style. In this example, a set of base look-up tables are created for the general vehicle platform/powertrain segment. Individual user driving style may then be captured as real-time sample points of fuel use taken over a discrete variety of speeds, road grades, and delta steering angles. This data may be used to generate an updated or alternate fuel economy map and corresponding look-up table. If threshold conditions are met (e.g., new mean of circular buffer points, large differences from base table, etc.), one or more new values from the updated/alternate fuel consumption (FC) table(s) will replace the corresponding values in the base FC table(s). Circular buffer points allow for an automatic reset (e.g., vehicle was towing a trailer) and adaption (e.g., vehicle becomes less fuel efficient over time). For instance, each time a subject vehicle is operating in the vicinity of an operating point/region of a fuel economy table, resident vehicle sensors capture an actual, measured current value of the fuel economy. This value is compared to the current point in the base table, and a logic or mathematical decision is made of whether or not to replace the current table point value with the measured point value.

A circular buffer computing method may be used to “trigger” the writing of a new fuel consumption table or the overwriting of an existing table value based on evaluation criteria applied to a set of sample points over a preset size. A circular buffer is a computing operation where memory is used for a preset window of time or a preset number of sample points, and thereafter begins to overwrite itself. In so doing, sample point values may be captured, e.g., every five (5) minutes or 300 samples (1 sample per memory location). At the next step in time, e.g., five minutes and one second or the 301st data point, the memory is reused starting at the first position. This allows a finite amount of memory to be used over an unknown or protracted period of time. In predefined process block 115, the method 100 may capture a stream of data to calculate fuel economy table points. Once captured, a logical or mathematical comparison is made to decide if a captured value in the buffer should replace an existing value that is currently in a table being used for routing calculations.

A trigger event, such as a travel route selection, an ignition cycle, a delta change between an existing table value and a real-time measured value, will enable the writing to resident memory of an updated table point value in a circular buffer, with the intent of evaluating and using the new buffer value(s) to replace value(s) in the original FC base table(s). In one example, a circular buffer is created for each defined discrete speed/road grade/previous turn angle point value or region of a look-up map or table. Optionally, a subset of discrete speed/road grade/previous turn angle point values or regions of a look-up table or map are sampled while other points/regions are populated or adjusted using an interpolation or extrapolation method. For at least some embodiments, the data collection, computation and storage of a FC table, circular buffer, and trigger logic may be performed locally, e.g., using a telematics unit, or remotely, e.g., using a wireless “cloud” services, or in some combinatorial configuration.

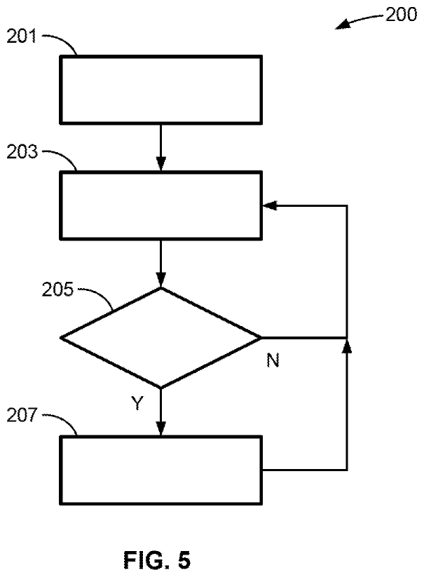

Real-time fuel consumption values may be calculated when the vehicle is driving at operating conditions within the data point regions defined in a table. New, real-time fuel consumption values may be first written to a “rightmost” circular buffer memory location at a selectable sample rate (e.g., 1 Hz) to the circular buffer. Entries are stored for (at maximum) a total size of buffer length “C”; at that time, an oldest entry in the buffer (e.g., far left) is discarded, all buffer values shift left, and the new entry is added at the rightmost position. A history length “N” of the buffer allows for adjustments to the number of entries for each table location from the maximum size “C” (e.g., to the minimum of one entry). Actual replacement of a base FC table value with a new measured value based on buffer entries is executed based on a trigger event, such as those described below with respect to the flowchart of FIG. 5. Sample points over size “P” may be evaluated, e.g., a mean, a mode, a min, a max, etc., to obtain a replacement value.

A previous steering angle FC accumulator may be used for learning and evaluating values for fuel consumption value comparisons and to trigger a table write operation. While driving, a real-time steering angle accumulator tracks and accumulates a total amount of steering activity that takes place over a selected time period, travel distance, travel speed, and/or travel route. More steering movement for a given vehicle/driver over a particular distance and speed generally tends toward less fuel economy. By calculating an accumulator value of the steering angle accumulator in real time, and comparing the real-time accumulator value to a value calculated a priori for a select driver, time period, travel distance, travel speed, travel route, etc., the resulting difference may be used for relative FC comparisons. For instance, a memory location holds a numeric value, which is based on an additive accumulation of the instantaneous absolute value of the steering angle over a selected time sampling rate multiplied by a corresponding weight factor created (e.g. by averaging) from values in the FC map of speed and road grade. As another option, a memory location holds a numeric value, which is based on a predicted additive accumulation of the absolute value of the steering angles over a selected route and multiplied by a corresponding predicted weight factor over a selected route created (e.g. by averaging) from values in the FC map of speed and road grade.

With reference now to the work flowchart of FIG. 5, an improved method or control strategy for adapting fuel consumption look-up tables to an individual vehicle/driver is generally described at 200 in accordance with aspects of the present disclosure. Some or all of the operations illustrated in FIG. 5 and described in further detail below may be representative of an algorithm that corresponds to processor-executable instructions that may be stored, for example, in main or auxiliary or remote memory, and executed, for example, by an on-board or remote controller, processing unit, control logic circuit, or other module or device, to perform any or all of the above or below described functions associated with the disclosed concepts. It should be recognized that the order of execution of the illustrated operation blocks may be changed, additional blocks may be added, and some of the blocks described may be modified, combined, or eliminated.

At process block 201, a base fuel consumption (FC) look-up table is produced for a range of speeds, road grades, and turn angles, e.g., in any of the manners described hereinabove or in any available and suitable manner. At process block 203, a real-time fuel consumption value (e.g., Instantaneous Fuel Consumption (IFC)) is recorded for each condition/location of the look-up tables. Process block 203 may also include comparing the recorded values to measured values taken at the same driving condition (e.g., speed, grade, angles, etc.). As mentioned above, individual driving styles (aggressive or conservative, delta steering angles, etc.) may be captured as sample points of fuel consumption taken over a discrete variety of speed, road grade, turn angles, etc. Method 200 of FIG. 5 continues to decision block 205 to determine if an absolute delta value is greater than a preset percentage (e.g., 10%) or a preset value. Responsive to a determination that the absolute delta value is not greater than the preset percentage/value (block 205=N), the method 200 loops back to process block 203. Conversely, if the absolute delta value is in fact greater than the preset percentage/value (block 205=Y), the method 200 concludes that trigger conditions are met for a table update and responsively proceeds to process block 207 and updates a corresponding value or group of values in the base look-up table. In so doing, the one or more look-up tables may be adapted to an individual driver for better fuel consumption estimation.

There may be use cases where a “favored” or “best” route suggested by a navigation system or dedicated software application is determined to no longer be the per se optimal route. This may be due to a recalculation that is triggered by any of the modified fuel consumption table processes described above. Consequently, fuel consumption map information for base tables and/or real-time modified tables can be used to alter the suggested route recommendation to one that is more “Eco” conscious for a given vehicle/driver. Optimal fuel economy may be reached by operating the vehicle at an optimal speed target, e.g., modulating vehicle speed to more closely coincide with a target speed or target speed range as dictated by an FC map. Referring to the FC map information of FIGS. 3A, 3B, 4A and 4B, for example, the system can infer that travel above 60 mph is likely not fuel optimal. If a learned FC map captures that the vehicle drag is higher or the driver has a tendency to speed, travel route average speeds above 60 mph are deemed to be even less fuel efficient. Other considerations may include traffic delays, multiple toll points, or more chances of traffic intersection stops on a route. Each of these factors cause a vehicle to operate in a lower speed range, which is less efficient over longer driving durations.

Aspects of this disclosure may be implemented, in some embodiments, through a computer-executable program of instructions, such as program modules, generally referred to as software applications or application programs executed by an onboard vehicle computer or a distributed network of resident and remote computing devices. Software may include, in non-limiting examples, routines, programs, objects, components, and data structures that perform particular tasks or implement particular data types. The software may form an interface to allow a resident vehicle controller or control module or other suitable integrated circuit device to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network architectures, including multiprocessor systems, microprocessor-based or programmable-consumer electronics, minicomputers, mainframe computers, master-slave, peer-to-peer, or parallel-computation frameworks, and the like. In addition, aspects of the present disclosure may be practiced in distributed-computing environments where tasks are performed by resident and remote-processing devices that are linked through a communications network. In a distributed-computing environment, program modules may be located in both onboard and off-board computer-storage media including memory storage devices. Aspects of the present disclosure may therefore, be implemented in connection with various hardware, software or a combination thereof, in a computer system or other processing system.

Any of the methods described herein may include machine-readable instructions for execution by: (a) a processor, (b) a controller, and/or (c) any other suitable processing device. Any algorithm, software, control logic, protocol, or method disclosed herein may be embodied in software stored on a tangible medium such as, for example, a flash memory, a CD-ROM, a floppy disk, a hard drive, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, there are many other methods for implementing the example machine readable instructions that may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method for controlling operation of a motor vehicle, the motor vehicle including a plurality of road wheels, a prime mover operable to drive at least one of the road wheels, and a resident vehicle controller operable to control the prime mover, the method comprising:
determining, via the resident vehicle controller, a vehicle origin and a vehicle destination for the motor vehicle;
conducting, via the resident vehicle controller with a memory-stored map database, a geospatial query to identify a plurality of candidate routes for the motor vehicle to traverse from the vehicle origin to the vehicle destination;
receiving respective road-level data associated with each of the candidate routes, the road-level data including speed data and turn angle data and/or gradient data;
estimating a respective total energy use of the prime mover to propel the motor vehicle from the vehicle origin to the vehicle destination across each of the candidate routes, the estimating including evaluating the respective road-level data of the candidate route against a memory-stored table correlating energy consumption to speed and turn angle and/or gradient; and
transmitting, via the resident vehicle controller, a command signal to a resident vehicle subsystem to execute a control operation based on at least one of the estimated total energy uses corresponding to at least one of the candidate routes.

2. The method of claim 1, wherein estimating the total energy uses for the candidate routes includes:
dissecting each of the candidate routes into multiple road segments;
determining, from the road-level data stored in the memory-stored map database, a respective average speed, average turn angle, and average gradient for each of the road segments;
estimating a respective vehicle energy use for each of the road segments by evaluating the respective average speed, turn angle, and gradient of the road segment against the memory-stored table correlating energy consumption to speed and turn angle and/or gradient; and
aggregating the vehicle energy uses of the road segments to thereby estimate the respective total energy uses for each of the candidate routes.

3. The method of claim 1, wherein estimating the respective total energy use for the candidate routes includes:
receiving vehicle dynamics data indicative of speed, turn angle, and gradient for multiple participatory vehicles while travelling on the candidate routes for a fixed time window;
determining, from the received vehicle dynamics data, a respective average speed, average turn angle, and average gradient as the respective road-level data associated with each of the candidate routes; and
estimating the respective total energy use for each of the candidate routes by evaluating the respective average speed, average turn angle, and average gradient of the candidate route against the table correlating energy consumption to speed and turn angle and/or gradient.

4. The method of claim 1, wherein the resident vehicle subsystem includes a vehicle navigation system with an input device and an electronic display device, the method further comprising:
displaying, via the electronic display device, each of the candidate routes contemporaneous with an indication of the respective estimated total energy use;
receiving, via the input device, a user selection of one of the candidate routes;
determining if a disturbance event has increased an estimated travel time for the selected candidate route by at least a predetermined threshold time; and
displaying, via the electronic display device responsive to the disturbance event increasing the estimated travel time by the predetermined threshold time, a prompt to select another one of the candidate routes.

5. The method of claim 6, further comprising, responsive to the disturbance event increasing the estimated travel time by the predetermined threshold time:
conducting a second geospatial query to identify a plurality of alternate candidate routes for the motor vehicle to traverse from the vehicle origin to the vehicle destination;
receiving, from the memory-stored map database or multiple participatory vehicles, respective road-level data associated with each of the alternate candidate routes;
estimating, by evaluating the respective road-level data of the alternate candidate routes against the memory-stored table correlating energy consumption to speed and turn angle and/or gradient, a respective total energy use of the prime mover to propel the motor vehicle from the vehicle origin to the vehicle destination across each of the alternate candidate routes; and
displaying, via the electronic display device, each of the alternate candidate routes contemporaneous with an indication of the respective estimated total energy use.

6. The method of claim 6, wherein the predetermined threshold time includes a preset time value or a preset time percentage.

7. The method of claim 1, further comprising:
determining, from the road-level data, a respective estimated travel time and distance for each of the candidate routes,
wherein the control operation is further based on at least one of the estimated travel times and distances corresponding to at least one of the candidate routes.

8. The method of claim 1, wherein the memory-stored table includes a first look-up table correlating energy consumption to speed and turn angle, the first look-up table defining a first optimal operating region determined to minimize vehicle energy use, and wherein the resident vehicle subsystem includes an autonomous driving control module operable to automate driving of the motor vehicle, the control operation including operating the motor vehicle within the first optimal operating region.

9. The method of claim 1, wherein the memory-stored table includes a second look-up table correlating energy consumption to speed and gradient, the second look-up table defining a second optimal operating region determined to minimize vehicle energy use, and wherein the resident vehicle subsystem includes an autonomous driving control module operable to automate driving of the motor vehicle, the control operation including operating the motor vehicle within the second optimal operating region.

10. The method of claim 1, further comprising:
receiving real-time energy consumption data indicative of actual energy use of the prime mover at designated speeds and turn angles and/or gradients corresponding to sample points within the memory-stored table;
determining, for each of the sample points, if the respective actual energy use is different from a respective memory-store energy use for the sample point by at least a predetermined usage delta; and
responsive to the respective actual energy use being different from the respective memory-store energy use for the sample point by at least the predetermined usage delta, updating the memory-stored table to replace the memory-store energy use with the actual energy use.

11. The method of claim 10, further comprising, prior to receiving the real-time energy consumption data, determining if the motor vehicle is operating at a speed and turn angle or a speed and gradient that corresponds to any one of the sample points within the memory-stored table.

12. The method of claim 1, wherein receiving the respective road-level data and estimating the total energy uses for the candidate routes are executed by the resident vehicle controller.

13. The method of claim 1, wherein the resident vehicle subsystem includes an Advanced Driver Assistance System (ADAS) control module operable to govern driving of the motor vehicle, and wherein the control operation includes executing an automated steering maneuver and/or an automated cruise control maneuver adapted by the ADAS control module based on the at least one of the estimated total energy uses.

14. The method of claim 1, wherein the resident vehicle subsystem includes a vehicle navigation system with an electronic display device, and wherein the control operation includes saving the estimated total energy uses for the candidate routes in the memory-stored map database and/or displaying each of the candidate routes contemporaneous with an indication of the respective estimated total energy use on the electronic display device.

15. A motor vehicle comprising:
a vehicle body;
a plurality of road wheels attached to the vehicle body;
a prime mover attached to the vehicle body and configured to drive at least one of the road wheels and thereby propel the motor vehicle;
a vehicle navigation system attached to the vehicle body and including an input device and an electronic display device; and
a resident vehicle controller attached to the vehicle body and programmed to:
determine a vehicle origin and a vehicle destination for the motor vehicle;
conduct, via a memory-stored map database, a geospatial query to identify a plurality of candidate routes for the motor vehicle to traverse from the vehicle origin to the vehicle destination;
receive respective road-level data associated with each of the candidate routes, the road-level data including speed data and turn angle and/or gradient data;
estimate a respective total energy use of the prime mover to propel the motor vehicle from the vehicle origin to the vehicle destination across each of the candidate routes, the estimating including evaluating the respective road-level data of the candidate route against a memory-stored table correlating energy consumption to speed and turn angle and/or gradient; and
transmit a command signal to a resident vehicle subsystem to execute a control operation based on at least one of the estimated total energy uses corresponding to at least one of the candidate routes.

16. The motor vehicle of claim 15, wherein estimating the total energy uses for the candidate routes includes:
dissecting each of the candidate routes into multiple road segments;
determining, from the road-level data stored in the memory-stored map database, a respective average speed, average turn angle, and average gradient for each of the road segments;
estimating a respective vehicle energy use for each of the road segments by evaluating the respective average speed, turn angle, and gradient of the road segment against the memory-stored table correlating energy consumption to speed and turn angle and/or gradient; and aggregating the vehicle energy uses of the road segments to thereby estimate the respective total energy uses for each of the candidate routes.

17. The motor vehicle of claim 16, wherein estimating the respective total energy use for the candidate routes includes:
receiving vehicle dynamics data indicative of speed, turn angle, and gradient for multiple participatory vehicles while travelling on the candidate routes for a fixed time window;
determining, from the received vehicle dynamics data, a respective average speed, average turn angle, and average gradient as the respective road-level data associated with each of the candidate routes; and
estimating the respective total energy use for each of the candidate routes by evaluating the respective average speed, average turn angle, and average gradient of the candidate route against the table correlating energy consumption to speed and turn angle and/or gradient.

18. The motor vehicle of claim 15, wherein the resident vehicle controller is further configured to:
display, via the electronic display device of the vehicle navigation system, each of the candidate routes contemporaneous with an indication of the respective estimated total energy use;
receive, via the input device, a user selection of one of the candidate routes;
determine if a disturbance event has increased an estimated travel time for the selected candidate route by at least a predetermined threshold time; and
display, via the electronic display device responsive to the disturbance event increasing the estimated travel time by the predetermined threshold time, a prompt to select another one of the candidate routes.

19. The motor vehicle of claim 15, wherein the resident vehicle controller is further configured to determine, from the road-level data, a respective estimated travel time and distance for each of the candidate routes, wherein the control operation is further based on at least one of the estimated travel times and distances corresponding to at least one of the candidate routes.

20. The motor vehicle of claim 15, wherein the memory-stored table includes a first look-up table correlating energy consumption to speed and turn angle, the first look-up table defining a first optimal operating region determined to minimize vehicle energy use, and wherein the resident vehicle subsystem includes an autonomous driving control module operable to automate driving of the motor vehicle, the control operation including operating the motor vehicle within the first optimal operating region.
